(19) United States
(12) Patent Application Publication
(10) Pub. No.: US 2010/0085751 A1
(43) Pub. Date: Apr. 8, 2010

(54) Enclosures for Light Sources

(76) Inventor: Jeff Shaner, Covington, GA (US)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/411,723

(22) Filed: Mar. 26, 2009

Related U.S. Application Data
(60) Provisional application No. 61/039,647, filed on Mar. 26, 2008.

(51) Int. Cl. F21S 4/00; F21V 17/00; F21V 29/00

(52) U.S. Cl. 362/249.02; 362/375; 362/373

(57) ABSTRACT

Embodiments of the present invention provide enclosures for light sources, such as, but not limited to, LEDs, and their circuitry that obviate the need for separate enclosures. The light sources and their circuitry are mounted on a support structure that serves as a heat sink and protected from the environment by a flame resistant and partially transparent protective cover. Multiple such enclosures may be used in a light fixture.

### CROSS REFERENCE TO RELATED APPLICATION

This application claims the benefit of U.S. provisional application Ser. No. 61/039,647, entitled “LED Enclosure and Area Light” and filed Mar. 26, 2008, the entire contents of which are hereby incorporated by this reference.

### FIELD OF INVENTION

The invention is directed to enclosures for light sources and lighting fixtures that use such enclosures.

### BACKGROUND OF INVENTION

Light fixtures covering large areas are well known in the art. Such light fixtures used in outdoor applications are continuously exposed to the elements and must be able to withstand such exposure. These light fixtures must be able to protect the electrical components while allowing the light to be adequately emitted from the fixture. Many traditional outdoor light fixtures employ a housing that surrounds and protects all components of the light fixture. For safety concerns, all the components of the light fixture must be enclosed according to such standard setting bodies as Underwriters Laboratories (UL). Traditionally, in order to satisfy these standards, all the hazardous components of the light fixture (wiring, circuitry, etc.) have been enclosed behind barriers, preferably made from metal, which is considered inherently safe by UL. However, since light could not escape from such enclosures, the light sources (including lamps and reflectors needed to direct the light) have been maintained separately from its associated electrical components. This is especially true in light fixtures utilizing light emitting diodes (“LEDs”). LEDs have traditionally been separated and maintained in different enclosures than their circuitry. In fact, the hazardous voltage-producing circuitry of the LEDs has traditionally been enclosed within multiple layers of metal, glass, or potting compound, greatly complicating the construction of such fixtures. Therefore, there exists a need to provide a means to enclose the light sources and dangerous circuitry together in a simplified construction while satisfying industry safety requirements.

### SUMMARY OF THE INVENTION

Embodiments of the present invention provide enclosures for light sources, such as, but not limited to, LEDs, and their circuitry that obviate the need for separate and complex enclosures. The light sources and their circuitry are mounted on a support structure that serves as a heat sink and protected from the environment by a flame resistant and partially transparent protective cover. Multiple such enclosures may be used in a light fixture.

### BRIEF DESCRIPTION OF THE FIGURES

FIG. 1 shows a perspective view of an enclosure according to one embodiment of this invention.

FIG. 2 shows an exploded view of the enclosure of FIG. 1.

FIG. 3 shows a bottom perspective view of the light fixture with a plurality of enclosures of FIG. 1.

FIG. 4 shows a top perspective view of the light fixture of FIG. 3.

FIG. 5 shows a top plan view of the light fixture of FIG. 3.

### DETAILED DESCRIPTION OF INVENTION

Embodiments of this invention provide enclosures for protecting light sources from environmental elements while meeting various safety and manufacturing regulations. The enclosure encapsulates the electrical and light producing components in a single body in an acceptable material, protecting them from the environment while allowing light to escape from the enclosure.

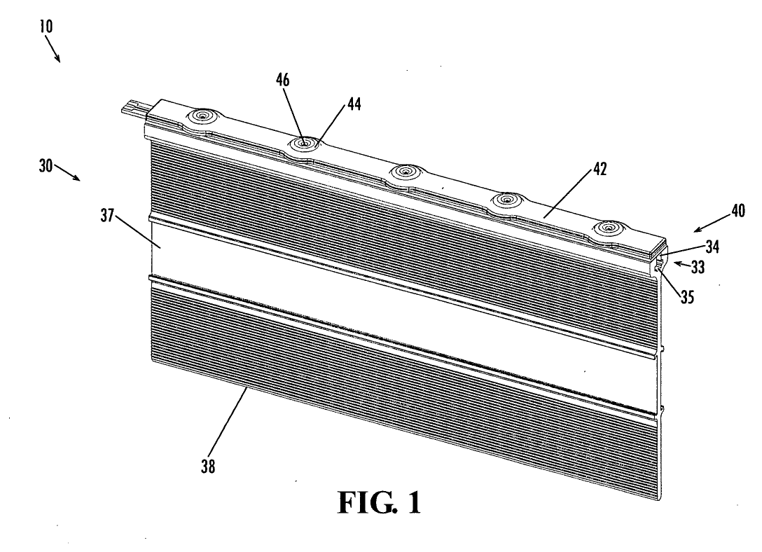

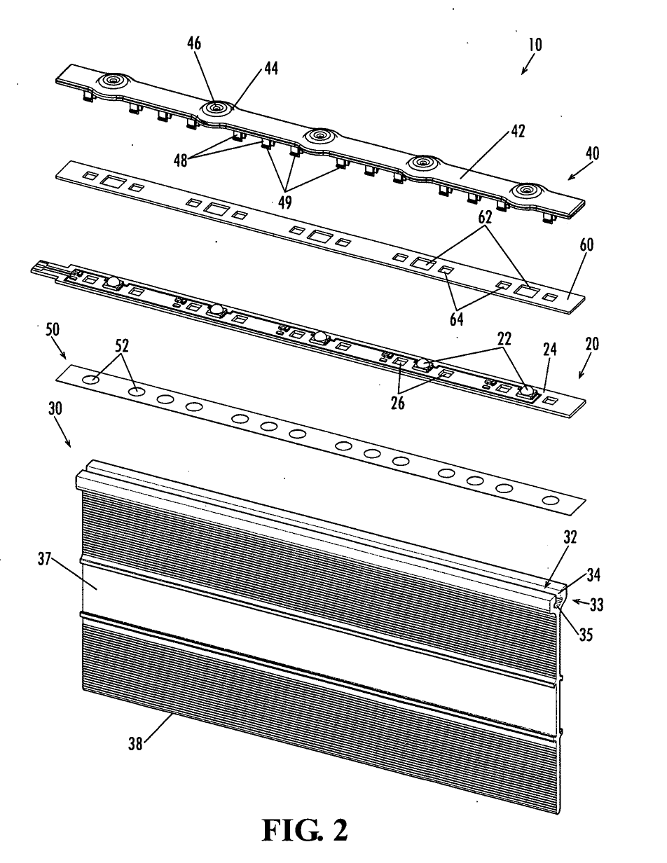

FIGS. 1-2 illustrate an enclosure 10 according to one embodiment of this invention. The enclosure 10 contains both the light source and the light source's electrical components, eliminating the need for two separate enclosures. The enclosure 10 includes a light source 20 enclosed between a support structure 30 and an enclosure cover 40. The light source 20 as shown in FIG. 2 includes light emitting diodes (“LEDs”) 22. Note, however, that other light fixtures may use other types of light sources and is not limited to use with only LEDs 22. Light sources such as, but not limited to, organic LEDs, incandescents, and fluorescents may be used. However, given that most of the light fixtures are used to light large areas, LEDs and other high wattage light sources are preferable. Any number of LEDs 22 are mounted to a light board 24. The LEDs may be mounted in any arrangement along the light board 24. As shown, the LEDs are mounted to a high wattage printed circuit board 24. The light board 24 may include apertures 26 as well, which will be discussed below.

The light source 20 is supported and partially retained by the support structure 30. The light source 20 can be mounted flush on an exterior surface of the support structure 30. Alternatively and as shown, the light source 20 can be retained within a trough 32 in an upper portion 33 of the support structure 30. A groove 34 may extend from the bottom of the trough 32 and connect with a wider channel 35 in the upper portion 33 of the support structure 30, the importance of which will be discussed below. A blade portion 37 extends downwards from the upper portion 33 to form a lower portion 38. The blade portion 37 acts as a heat sink for the light source 20 and its electrical components. Thus, the dimensions of the blade portion 37 may be tailored depending on the anticipated heat generated by the light source 20. The support structure 30 may be manufactured from aluminum to assist in heat dissipation. While aluminum is preferable, the support structure 30 may be made from steel, copper, or other various thermally conductive materials. In addition, a heat conducting body 50 may be placed between the light source 20 and the support structure 30, which increases thermal transfer between the light source 20 and the support structure 30. As shown, the heat conducting body 50 is a silicone impregnated cloth 50. The heat conducting body 50 may include apertures 52 that align with apertures 26 of the light board 24.

The enclosure cover 40 secures and partially retains the light source 20 to the support structure 30. It is preferable, but not required, to form the enclosure cover 40 from materials that have a flame resistance rating of UL 94 5VA, as detailed in the UL literature. Additionally, it is preferable, but not required, to form the enclosure cover 40 from materials that meet UL creepage and clearance requirements based upon the configuration of the enclosure 10 and its components. Preferably, the enclosure cover 40 is made from a polymeric material, such as, but not limited to, polycarbonate, polystyrene, or acrylic. Use of polymeric materials allows the enclosure cover 40 to be injection-molded, but other manufacturing methods, such as, but not limited to, machining, stamping, compression-molding, etc., may also be employed. While polymeric materials may be preferred, other materials, such as, but not limited to, glass, topaz, sapphire, silicone, epoxy resin, etc. can be used to form the enclosure cover 40. It is desirable to use materials that have the ability to withstand exposure to a wide range of temperatures.

The enclosure cover 40 includes a base 42. The dimensions of the base 42 can substantially match the dimensions of the trough 32 of the support structure 30 to ensure a secure fit. Lighting apertures 44 and lenses 46 are positioned along the base 42, with the lenses 46 oriented in the lighting apertures 44. In the preferred embodiment, the lenses 46 are molded into and are an integral part of the enclosure cover 40. The lenses 46 are positioned on the enclosure cover 40 to align with the LEDs 22 and thus at least the lenses 46 of the enclosure cover 40 need to be partially transparent to allow light emitted by the LEDs 22 to escape the enclosure 10. The lenses 46 may be made from a polymeric material, just like the rest of the enclosure cover 40, but other materials discussed above may be used as well in other embodiments. It is preferable to form the lenses 46 out of a material with non-yellowing capabilities with respect to ultraviolet light. Mounting arms 48 may extend from the bottom surface of the enclosure cover 40. An anchor 49 may be positioned on the end of the mounting arms 48. These anchors 49 facilitate retention of the enclosure cover 40 on the support structure 30, as discussed in more detail below.

The enclosure 10 may include, but does not have to include, a weather resistant gasket 60, which assists in sealing the light source 20 and its associated electrical circuitry from damaging environmental elements. The gasket 60 is formed of a compressible material (e.g., silicone sponge, rubber, neoprene, etc.) that has dimensions that substantially match those of the trough 32 of the support structure 30 and the enclosure cover 40. The gasket 60 may include light apertures 62 that correspond to the LEDs 22 of the light source 20, as well as securing apertures 64 corresponding to the apertures 26 and 52 of the light board 24 and conducting body 50, respectively.

The enclosure cover 40 is mounted to the support structure 30 with the optional gasket 60, light source 20, and the silicone cloth 50, enclosed. The base 42 of the enclosure cover 40 fits substantially flush within the trough 32 of the support structure 30, with the light apertures 44 aligned with the light apertures 62 and LEDs 22 of the gasket 60 and light source 20 respectively. When mounting the enclosure cover 40, the mounting arms 48 are inserted through the apertures 62, 26, and 52 of the gasket 60, light source 20, and silicone cloth 50, respectively. The mounting arms 48 flex inwardly to allow the anchors 49 to pass through the groove 34 of the support structure 30, and into the channel 35, where the mounting arms 48 and associated anchors 49 expand to retain the enclosure cover 40 on the support structure 30. When fully assembled, the components form a weather-tight, rigid, flame resistant enclosure 10 obviating the need to separately enclose the LEDs 22 and its circuitry 24.

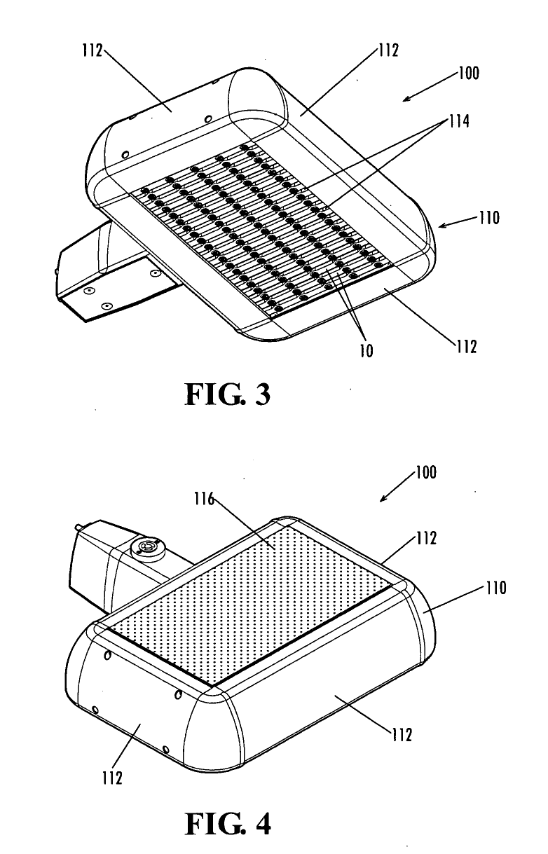

As shown in FIGS. 3-5, the enclosures 10 may be assembled into a light fixture 100. Multiple enclosures 10 may be retained within a housing 110 of the lighting fixture 100, as shown in FIG. 3. Preferably, the lower portions 38 of the support structures 30 are oriented along the top portion of the housing 110, with the enclosure covers 40, including the lenses 46 and the LEDs 22, being visible from below. However, in other embodiments, the enclosures 10 may be oriented so as to have light directed in any direction. Drivers (not shown) that power the light sources 20 may be retained in the external portions 112 of the fixture housing 110.

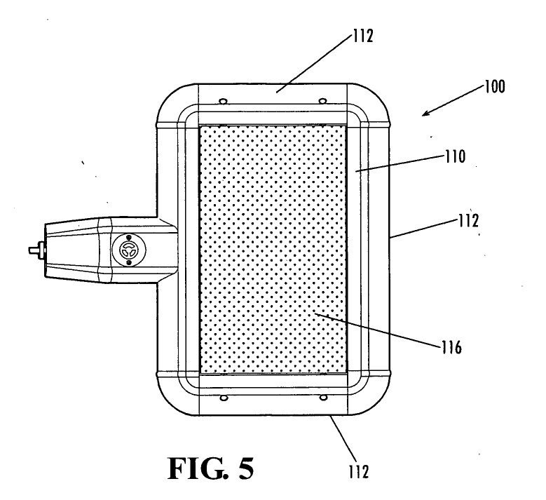

The enclosures 10 may be aligned in parallel with one another, as shown in FIG. 3 or in other ways within the fixture housing 110. The alignment may create gaps 114 between adjacent enclosures 10. The housing 110 may have a perforated top surface 116, as shown in FIGS. 4-5. The perforated top surface 116 allows air and, in outdoor applications, water to flow around the enclosures 10, providing a means for cooling the enclosures 10, as well as a means to remove dust and small debris. The perforated top 116 also prevents large debris, such as leafs and large insects, from entering the housing 110. Additionally, the combination of the gaps 114 and the perforated top surface 116 allow for water to pass through the fixture 100 and escape through the bottom of the housing 110 and air to circulate through the fixture 100 and between adjacent enclosures 10, carrying away heat from the enclosures 10.

The foregoing has been provided for purposes of illustration of an embodiment of the present invention. Modifications and changes may be made to the structures and materials shown in this disclosure without departing from the scope and spirit of the invention.

We claim:

1. An enclosure comprising:
(a) a light source;
(b) an at least partially transparent enclosure cover; and
(c) a support structure configured to partially receive the light source and enclosure cover,
wherein the enclosure cover retains and seals the light source between the support structure and the enclosure cover while allowing light produced by the light source to escape the enclosure.

2. The enclosure of claim 1, wherein the light source comprises a plurality of light emitting diodes.

3. The enclosure of claim 2, wherein the enclosure cover comprises:
(a) a polymeric material; and
(b) at least one lens.

4. The enclosure of claim 1, further comprising a gasket mounted between the enclosure cover and the light source.

5. The enclosure of claim 1, wherein the support structure comprises a thermally conductive material.

6. The enclosure of claim 5, further comprising a heat conducting body located between the light source and the support structure.

7. The enclosure of claim 1, wherein the support structure comprises a groove and the enclosure cover further comprises a plurality of mounting arms adapted to engage the groove and secure the enclosure cover to the support structure.

8. A lighting fixture comprising a housing having a perforated top portion and adapted to retain at least one enclosure of claim 1.

9. The lighting fixture of claim 8, wherein the at least one enclosure comprises a plurality of enclosures and wherein the plurality of enclosures are retained in parallel in the housing so as to create gaps between adjacent enclosures.
